(19) United States
(12) Patent Application Publication
(10) Pub. No.: US 2016/0093919 A1
(43) Pub. Date: Mar. 31, 2016

(54) Vanadium Solid-Salt Battery

(71) Applicants: Tohoku Techno Arch Co., Ltd., Sendai-shi (JP); Brother Kogyo Kabushiki Kaisha, Nagoya-shi (JP)

(72) Inventors: Shigeki Yoshida, Toyoake-shi (JP); Tomoo Yamamura, Sendai-shi (JP); Kiyoshi Sakamoto, Sendai-shi (JP)

(21) Appl. No.: 14/954,476

(22) Filed: Nov. 30, 2015

Related U.S. Application Data
(63) Continuation of application No. PCT/JP2014/056226, filed on Mar. 11, 2014.

(30) Foreign Application Priority Data
May 31, 2013 (JP) 2013-115536

(51) Int. Cl. H01M 10/36; H01M 4/58; H01M 4/66; H01M 2/02

(52) U.S. Cl. CPC H01M 10/36; H01M 2/0207; H01M 2/024; H01M 2/029; H01M 2/026; H01M 2/0262; H01M 4/5825; H01M 4/663; H01M 2004/027

(57) ABSTRACT

The present disclosure relates to a vanadium solid-salt battery including: a power generating unit including first and second electrode members each containing vanadium, a separator separating the first and second electrode members from each other, and an electrolyte; a first sheet making contact with the first electrode member; a first flat plate-shaped conductive member making surface contact with the first sheet; a second sheet making contact with the second electrode member; a second flat plate-shaped conductive member making surface contact with the second sheet; a third sheet covering the first and second flat plate-shaped conductive members; and a first bonding portion bonding a peripheral portion of the third sheet so that at least portions of the first flat plate-shaped conductive member, the first sheet, the power generating unit, the second sheet and the second flat plate-shaped conductive member are pressure-bonded.

### CROSS REFERENCE TO RERATED APPLICATION

This application is a Continuation Application of International Application No. PCT/JP2014/056226 which was filed on Mar. 11, 2014 claiming the conventional priority of Japanese patent Application No. 2013-115536 filed on May 31, 2013.

### BACKGROUND OF THE INVENTION

1. Field of the Invention

The present disclosure relates to a vanadium battery using electrolyte containing vanadium as an active material. In particular, the present disclosure relates to a vanadium solid-salt battery (hereinafter referred also to as “VSSB”) containing a solid vanadium compound in the positive or negative electrode thereof.

2. Description of the Related Art

A secondary battery (rechargeable battery) is widely used not only for digital home electrical appliances but also for motor-powered electric automobiles and hybrid automobiles. As such a rechargeable battery, a redox-flow battery is known (U.S. Pat. No. 4,786,567). The redox-flow battery contains vanadium as an active material. The redox-flow battery uses two redox pairs producing Reduction/Oxidation (Redox) reaction in an electrolyte and performs electric charging/discharging by the change in ionic valence.

The redox pairs in the redox-flow battery can be exemplified by vanadium ions in +2 valence and +3 valence oxidation states (V²⁺ and V³⁺), and vanadium ions in +4 valence and +5 valence oxidation states (V⁴⁺ and V⁵⁺). An aspect of the redox-flow battery is exemplified by a liquid circulation-type redox-flow battery. In the liquid circulation-type redox-flow battery, a sulfuric acid solution of vanadium stored in a tank is supplied to a liquid circulation-type cell wherein the electric charging/discharging is performed. The liquid circulation-type redox-flow battery is used in the field of large electric power storage.

The liquid circulation-type redox-flow battery includes a tank for an electrolyte containing a positive electrode active material and a tank for an electrolyte containing a negative electrode active material, two stacks performing the electric charging/discharging, and a pump which feeds the positive electrode electrolyte or the negative electrode electrolyte to each of the stacks. Each of the electrolytes is fed from the tank to one of the stacks and is circulated between the tank and one of the stacks. Each of the stacks has such a configuration that an ion-exchange membrane is sandwiched between the positive and negative electrodes. In the redox-flow battery, the following reactions occur in the positive and negative electrodes, respectively.

Positive electrode:

VO²⁺(aq)+H₂O [symbol] VO₂⁺(aq)+e⁻+2H⁺ (1)

Negative electrode:

V³⁺(aq)+e⁻ [symbol] V²⁺(aq) (2)

In the formulae (1) and (2), the symbol “ [symbol] ” represents chemical equilibrium. In the present specification, the term “chemical equilibrium” means a state in which an amount of change in a product of reversible reaction coincides with an amount of change in a starting material. Further, the suffix “(aq)” added to the ions indicates that the ions exist in the solution. The symbol “ [symbol] ” and the suffix “(aq)” are used in the same meanings as described above, in any other formulae in the present specification.

In order to obtain a light-weight and compact redox battery having a high output performance, there is proposed a liquid static-type redox battery in which the electrolyte is not circulated (Japanese Patent Application Laid-open No. 2002-216833). This liquid static-type redox battery does not have any tank for electrolyte. Rather, the liquid static-type redox battery has a tank of electrolyte for positive side and a tank of electrolyte for negative side. The liquid static-type redox battery has a configuration wherein each of the tanks for positive side and negative side is filled with an electrolyte containing vanadium ion as an active material and a conductive material such as powder of carbon, etc.

Other than those described above, there is proposed a vanadium solid-salt battery (PCT International Publication WO2011/049103). The vanadium solid-salt battery includes an electrode supporting a deposited substance thereon, the deposited substance containing vanadium ion or positive ion including vanadium.

The vanadium solid-salt battery disclosed in PCT International Publication No. WO2011/049103 is quite useful in that the battery is light-weight and compact, and satisfies the demand for high energy density. Since such a vanadium solid-salt battery contains a small amount of electrolyte, the vanadium solid-salt battery is desired to have improved sealing property, without causing any leakage of the electrolyte, etc. Further, the vanadium solid-salt battery is desired to have a reduced internal resistance.

An object of the present disclosure is to provide a vanadium solid-salt battery with improved sealing property, without causing any leakage of the electrolyte, and with reduced internal resistance.

### SUMMARY OF THE INVENTION

According to an aspect of the present disclosure, there is provided a vanadium solid-salt battery characterized by including:

a power generating unit including a first electrode member and a second electrode member each of which contains vanadium ion or positive ion including vanadium, a separator which separates the first and second electrode members from each other, and an electrolyte;

a first sheet which is conductive and impermeable to the electrolyte and which makes contact with at least a portion of the first electrode member;

a first flat plate-shaped conductive member which makes surface contact with the first sheet;

a second sheet which is conductive and impermeable to the electrolyte and which makes contact with at least a portion of the second electrode member;

a second flat plate-shaped conductive member which makes surface contact with the second sheet;

a third sheet which is impermeable to the electrolyte and which covers the first and second flat plate-shaped conductive members; and

a first bonding portion which bonds a peripheral portion of the third sheet so that at least portions of the first flat plate-shaped conductive member, the first sheet, the power generating unit, the second sheet and the second flat plate-shaped conductive member are pressure-bonded (joined) in a state that the separator is sandwiched between the first and second sheets,

wherein the first flat plate-shaped conductive member, the first sheet, the power generating unit, the second sheet and the second flat plate-shaped conductive member are accommodated inside the third sheet.

### BRIEF DESCRIPTION OF DRAWINGS

FIG. 1 is a perspective view depicting the schematic configuration of an embodiment of a vanadium solid-salt battery.

FIG. 2 is a view depicting an image of cross-section (cross-section taken along I-I line) of a portion of the vanadium solid-salt battery of FIG. 1.

FIG. 3 is a view depicting an image of cross-section of a portion of another embodiment of the vanadium solid-salt battery.

FIG. 4 is a perspective view depicting the schematic configuration of yet another embodiment of the vanadium solid-salt battery.

FIG. 5 is a view depicting an image of cross-section (cross-section taken along IV-IV line) of a portion of the vanadium solid-salt battery of FIG. 4.

### DESCRIPTION OF PREFERRED EMBODIMENTS

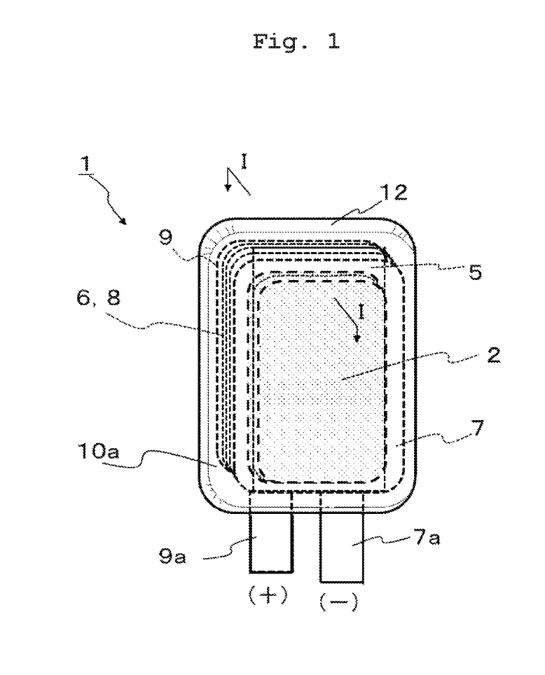

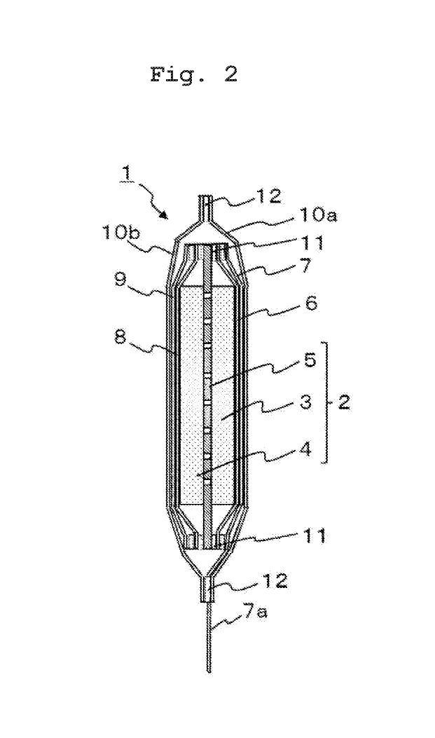

Firstly, the schematic configuration of an embodiment of a vanadium solid-salt battery of the present disclosure will be explained with reference to FIGS. 1 and 2. FIG. 1 is a perspective view depicting the schematic configuration of the vanadium solid-salt battery. FIG. 2 is a view depicting an image of the cross-section (taken along I-I line) of a portion of the vanadium solid-salt battery of FIG. 1.

As depicted in FIG. 1, a vanadium solid-salt battery 1 includes a power generating unit 2. The power generating unit 2 includes a first electrode member 3 and a second electrode member 4 each of which contains vanadium ion or positive ion including vanadium, a separator (separation membrane) 5 which separates (partitions) the first and second electrode members 3 and 4 from each other, and an electrolyte (not depicted in the drawings).

As depicted in FIG. 1 or FIG. 2, the vanadium solid-salt battery 1 is provided with a first sheet 6 which is conductive and impermeable to the electrolyte. The first sheet 6 makes contact with at least a portion of the first electrode member 3. In FIG. 1, the first sheet 6 makes surface contact with the first electrode member 3. The vanadium solid-salt battery 1 is provided with a first flat plate-shaped conductive member 7 which makes surface contact with the first sheet 6. The vanadium solid-salt battery 1 is provided with a second sheet 8 which is conductive and impermeable to the electrolyte. The second sheet 8 makes contact with at least a portion of the second electrode member 4. In FIG. 1 or FIG. 2, the second sheet 8 makes surface contact with the second electrode member 4. The vanadium solid-salt battery 1 is provided with a second flat plate-shaped conductive member 9 which makes surface contact with the second sheet 8. Further, the vanadium solid-salt battery 1 is provided with two third sheets 10a and 10b which are impermeable to the electrolyte. The first flat plate-shaped conductive member 7, the first sheet 6, the power generating unit 2, the second sheet 8 and the second flat plate-shaped conductive member 9 are arranged in this order. The first flat plate-shaped conductive member 7, the first sheet 6, the power generating unit 2, the second sheet 8 and the second flat plate-shaped conductive member 9 are accommodated by the third sheets 10a and 10b. The separator 5 is allowed to interpose between the first sheet 6 and the second sheet 8. The separator 5 preferably has an area greater than those of the first and second conductive members 3 and 4. It is possible to allow the separator 5, of which end portions are projected from the first and second electrode members 3 and 4, respectively, to be interposed between the first and second sheets 6 and 8. In the present specification, a term “members of battery” are the first flat plate-shaped conductive member 7, the first sheet 6, the power generating unit 2, the second sheet 8 and the second flat plate-shaped conductive member 9 which are arranged in this order. Further, in the present specification, the third sheet has a function as an exterior member which accommodates the members of battery therein. The third sheet is, for example, a member covering the power generating unit 2. Furthermore, in the present specification, even in a case that the third sheet is composed of two sheets, the sheets are referred to as the “third sheet”, with the same designation as the third sheet composed of a single sheet. In the present specification, the first and the second sheets, which are different from the third sheet, are each referred with an ordinal, such as “first” and “second”, designated for one sheet.

The first flat plate-shaped conductive member 7 is provided with a lead portion 7a of which portion is extended from the third sheet 10a and which is provided for external connection. The second flat plate-shaped conductive member 9 is provided with a lead portion 9a of which portion is extended from the third sheet 10b and which is provided for external connection.

As depicted in FIG. 2, the vanadium solid-salt battery 1 is provided with a bonding portion 12 bonding peripheral portions of the two third sheets 10a and 10b. The vanadium solid-salt battery 1 has a configuration wherein the members of battery are accommodated inside of the two third sheets 10 and 10b which are provided with the bonding portion 12 at the peripheral portions thereof. In the present specification, a term “first bonding portion” means a bonding portion 12 bonding the peripheral portion(s) of the third sheet (two third sheets).

In the vanadium solid-salt battery 1, the power generating unit 2 containing the electrolyte is accommodated within the two third sheets 10a and 10b which are provided with the bonding portion 12 at the peripheral portions thereof. Accordingly, the vanadium solid-salt battery 1 is capable of preventing any leakage of the electrolyte. Further, in the vanadium solid-salt battery 1, the power generating unit 2 is provided with a bonding portion 11 formed at peripheral portions, respectively, of the first and second sheets 6 and 8 with the separator 5 being interposed therebetween. The vanadium solid-salt battery 1 is doubly sealed by the first bonding portion 12 and the bonding portion 11. The vanadium solid-salt battery 1 has improved sealing property and is capable of preventing the leakage of electrolyte in an ensured manner In the present specification, a term “second bonding portion” means the bonding portion 11 bonding the first sheet 6 and the second sheet 8 tightly with each other in a state that the separator 5 is allowed to interpose therebetween. The second bonding portion 11 includes a bonding portion bonding the first sheet 6, the second sheet 8, the first flat plate-shaped conductive member 7 and the second flat plate-shaped conductive member 9.

In the vanadium solid-salt battery 1, the members of battery are accommodated inside the two third sheets 10a and 10b provided with the first bonding portion 12 at the peripheral portions thereof. The members of battery are the first flat plate-shaped conductive member 7, the first sheet 6, the power generating unit 2, the second sheet 8 and the second flat plate-shaped conductive member 9 which are arranged in this order. In the vanadium solid-salt battery 1, adjacent members in the members of battery are brought into pressurized contact with each other in the inside of the two third sheets 10a and 10b. Since the adjacent members in the members of battery are brought into pressurized contact with each other in the vanadium solid-salt battery 1, the electrical conductivity between the respective members is improved and the internal resistance can be reduced. The term “adjacent members” in the members of battery means any one of the following combination of two members, including: the first flat plate-shaped conductive member 7 and the first sheet 6, the first sheet 6 and the first electrode member 3, the first electrode member 3 and the separator 5, the separator 5 and the second electrode member 4, the second electrode member 4 and the second sheet 8, and the second sheet 8 and the second flat plate-shaped conductive member 9. Note that at least one combination among the combinations of the adjacent members may be brought into pressurized contact (be pressure-bonded). Further, in each of the combinations, at least portions of the adjacent members may be brought into pressurized contact (be pressure-bonded).

In the vanadium solid-salt battery 1, the first sheet 6 is interposed between the power generating unit 2 and the first flat plate-shaped conductive member 7. The power generating unit 2 and the first flat plate-shaped conductive member 7 do not directly contact with each other. Further, in the vanadium solid-salt battery 1, the second sheet 8 is interposed between the power generating unit 2 and the second flat plate-shaped conductive member 9. The power generating unit 2 and the second flat plate-shaped conductive member 9 do not directly contact with each other. In the vanadium solid-salt battery 1, since the power generating unit 2 containing the electrolyte does not make directly contact with the first flat plate-shaped conductive member 7 or the second flat plate-shaped conductive member 9, it is possible to suppress any corrosion of the flat plate-shaped conductive member which would otherwise be caused by the electrolyte. Accordingly, the vanadium solid-salt battery 1 can use, as the first flat plate-shaped conductive member 7 or the second flat plate-shaped conductive member 9, a metallic plate that is a good conductor.

Next, the respective members constructing the vanadium solid-salt battery 1 will be explained. In the present specification, the term “vanadium solid-salt battery” means such a battery that allows an active material to be deposited on the electrode members as a solid compound. The vanadium solid-salt battery contains the electrolyte. The amount of the electrolyte contained in the vanadium solid-salt battery is made to be an exact or proper amount at which the battery may be in the state of charge (SOC) of 0% to 100%.

### <Power Generating Unit>

As depicted in FIG. 2, the power generating unit 2 includes the first electrode member 3 and the second electrode member 4 each of which contains vanadium ion or positive ion including vanadium, the separator 5, and the electrolyte (omitted in the drawings). The separator 5 partitions the first and second electrode members 3 and 4 from each other.

### <Electrode Member>

The electrode member is such a member that is obtained by allowing a base member to support a deposited substance including a solid compound which contains, as an active material, vanadium as vanadium ion or positive ion including vanadium. A porous carbon material can be used for the base member of the electrode member.

### <Carbon Material>

A porous carbon material can be used for the base member of the electrode member. As the carbon material, it is preferable to use at least one kind of carbon material selected from the group consisting of: a carbon felt composed of carbon fiber, a carbon sheet composed of carbon fiber, activated carbon, and a sheet-shaped glassy carbon. It is more preferable to use, as the carbon material used as the base member of the electrode member, the carbon felt composed of carbon fiber or the activated carbon.

The carbon felt composed of carbon fiber is preferably composed of carbon short fibers of which diameter is in a range of 10 μm to 20 μm. Further, the basis weight of carbon felt is preferably in a range of 200 g/m² to 500 g/m², more preferably in a range of 250 g/m² to 450 g/m², particularly preferably in a range of 300 g/m² to 400 g/m².

The active carbon is preferably particulate active carbon. The particulate active carbon preferably has a specific surface area measured by the BET method in a range of 500 m²/g to 5,000 m²/g, a whole pore volume measured by t-plot method in a range of 0.1 mL/g to 1 mL/g, and a average particle diameter in a range of 5 μm to 20 μm. Here, the term “average particle diameter” means a median diameter on a volume basis measured by a laser diffraction/scattering grain size distribution measurement.

### <Active Material>

The active material is preferably a deposited substance of a solid compound containing vanadium ion or positive ion including vanadium. The deposited substance can be supported on a carbon material by applying or impregnating a solution, a semi-solid substance or a solid-substance containing the vanadium compound to or into the carbon material, and then by performing drying. The deposited substance is supported on the carbon material at a stage when the concentration of the vanadium compound in the solution, semi-solid substance or solid substance has exceeded the solubility. The semi-solid substance can be exemplified by a substance in a state of slurry obtained by adding, for example, an aqueous solution of sulfuric acid to the vanadium compound, a substance in a state of gel obtained by adding silica to the vanadium compound. The semi-solid substance or solid substance preferably has hardness or viscosity to such an extent for allowing the semi-solid substance or solid substance to adhere to the carbon material. The method for applying or impregnating the solution, semi-solid substance or solid substance on or into the carbon material can be exemplified by the doctor blade method, the dipping method, the spraying method, etc. Further, the drying method can be exemplified by a method for performing heating under a normal pressure and a method for performing drying under vacuum. The drying temperature is preferably in a range of about 20 degrees Celsius to about 180 degrees Celsius. In a case that the carbon material into which the solution, semi-solid substance or solid substance containing vanadium is impregnated is to be heated to be a temperature of not less than the normal temperature, a hot plate may be used. In a case that the carbon material into which the solution, semi-solid substance or solid substance containing vanadium is impregnated is to be dried under vacuum pressure, a degree of vacuum is preferably not more than 1×10⁵ Pa. The degree of vacuum is more preferably not more than 1×10⁴ Pa. Although the lower value of degree of vacuum is not particularly limited, the degree of vacuums is preferably not less than 1×10² Pa. In a case that the drying is performed under vacuum, it is possible to use an aspirator, a vacuum pump, etc.

### <Active Material for Negative Electrode>

The vanadium ion or positive ion including vanadium contained in the electrode member for the negative electrode is preferably vanadium ion of which oxidation number is changed between divalence and trivalence depending on the oxidation-reduction reaction (redox reaction). The vanadium ion of which oxidation number is changed between divalence and trivalence can be exemplified by V²⁺(II) and V³⁺(III).

The vanadium compound to be supported by the carbon material, as the active material for the negative electrode, can be exemplified by vanadium sulfate (II) (VSO₄.nH₂O) and vanadium sulfate (III) (V₂(SO₄)₃.H₂O). A mixture of the vanadium sulfate (II) and vanadium sulfate (III) may be also used. Here, “n” represents an integer that is 0 (zero) or is in a range of 1 to 6.

### <Active Material for Positive Electrode>

The vanadium ion or positive ion including vanadium contained in the electrode member for the positive electrode is preferably positive ion including vanadium of which oxidation number is changed between pentavalence and tetravalence depending on the oxidation-reduction reaction. The positive ion including vanadium of which oxidation number is changed between pentavalence and tetravalence can be exemplified by VO²⁺(IV) and VO₂⁺(V).

The vanadium compound to be supported by the carbon material, as the active material for the positive electrode, can be exemplified by vanadium oxide sulfate (IV) (vanadyl sulfate (IV)) (VOSO₄.nH₂O) and vanadium oxide sulfate (V) ((VO₂)₂SO₄.nH₂O). A mixture of the vanadium oxide sulfate (IV) and vanadium oxide sulfate (V) may be also used. Here, “n” represents an integer that is 0 (zero) or is in a range of 1 to 6.

### <Electrolyte>

The power generating unit 2 contains the electrolyte. The electrolyte is preferably an aqueous solution of sulfuric acid. As the aqueous solution of sulfuric acid, it is possible to use, for example, dilute sulfuric acid in which the concentration of the sulfuric acid is less than 90% by mass, etc. The amount of the electrolyte is made to be an exact or proper amount at which the battery may be in the state of charge (SOC) of 0% to 100%. The amount of the electrolyte is, for example, 70 mL of 2M (mol/L) sulfuric acid with respect to 100 g of the vanadium compound.

### <Separator>

As depicted in FIG. 2, the power generating unit 2 is provided with the separator (separation membrane) 5 which partitions the first electrode member 3 and the second electrode member 4 from each other. It is preferable that the separator 5 has an area greater than those of the first and second electrode members 3 and 4. In the separator 5, end portions of the separator 5 which protrude from the first and second electrode members 3 and 4 are arranged between the first Sheet 6 and the second Sheet 8.

It is allowable to use, as the separator 5, any separator provided that the separator allows the hydrogen ions (proton) to pass therethrough. As the separator, it is allowable to use, for example, a porous membrane, a nonwoven fabric, or an ion-exchange membrane which selectively allows the hydrogen ions to pass therethrough. The porous membrane is exemplified, for example, by a microporous film (membrane) formed of polyethylene (manufactured by Asahi Kasei Corporation), etc. Further, the nonwoven fabric is exemplified, for example, by “NanoBase (trade name)” (manufactured by Mitsubishi Paper Mills Limited), etc. Furthermore, the ion-exchange membrane is exemplified, for example, by “SELEMION (trade name) APS” (manufactured by Asahi Glass Co., Ltd.), etc.

In the power generating unit 2, the following reactions occur in the positive and negative electrodes, respectively.

Positive electrode:

VOX₂.nH₂O(s) [symbol] VO₂X.(n−1)H₂O(s)+HX+H⁺+e⁻ (3)

Negative electrode:

VX₃·nH₂O(s)+H⁺+e⁻ [symbol] VX₂·nH₂O(s)+HX (4)

In the reaction formulae of the reactions occurring in the positive and negative electrodes, respectively, “X” represents a monovalent anion. Note that, however, even in a case that “X” is a m-valent anion, it is possible to understand that coupling coefficient (1/m) is considered. Further, although the symbol “ [symbol] ” represents chemical equilibrium in the reaction formulae indicated here, the term “chemical equilibrium” in the formulae means a state in which an amount of change in a product of reversible reaction coincides with an amount of change in a starting material. Furthermore, in the reaction formulae, “n” indicates that “n” can take various values.

### <First Sheet 6 or Second Sheet 8>

As depicted in FIG. 2, the vanadium solid-salt battery 1 is provided with the first sheet 6. The first sheet 6 makes contact with at least a portion of the first electrode member 3 of the power generating unit 2. Further, the vanadium solid-salt battery 1 is provided with the second sheet 8. The second sheet 8 makes contact with at least a portion of the second electrode member 4 of the power generating unit 2. The size of the first or second sheet 6 or 8 is not particularly limited. It is preferable that the first sheet 6 or the second sheet 8 has an area same as an area of the electrode member in the power generating unit 2, or has an area not less than the area of the electrode member in the power generating unit 2.

The first sheet 6 or the second sheet 8 is conductive and impermeable to the electrolyte. The sheet which is conductive and impermeable to the electrolyte is preferably any one of a conductive film, a sheet-shaped conductive rubber, or a graphite sheet. The conductive film can be exemplified by a polypyrrole sheet, etc. The sheet-shaped conducive rubber can be exemplified, for example, by a sheet-shaped conductive rubber which is not affected (invaded) by the electrolyte and which is obtained by adding a conductive material to a rubber material impermeable to the electrolyte, followed by being molded into a sheet-shape. The rubber material can be exemplified by natural rubber, isoprene rubber, butadiene rubber, styrene-butadiene rubber, chloroprene rubber, butyl rubber, silicone rubber, etc. The conductive material can be exemplified by natural graphite, graphite powder, carbon powder, carbon fiber, etc. The conductive rubber can be exemplified, for example, by “EC-A” (trade name, manufactured by Shin-Etsu Chemical Co., Ltd.), etc. The graphite sheet is a sheet obtained by graphitizing a polymer film by pyrolysis. The graphite sheet can be exemplified by “PSG graphite sheet” (trade name, manufactured by Panasonic Corporation), “Graphinity” (trade name, manufactured by Kaneka Corporation), etc. The first and second sheets 6 and 8 may contain an adhesive.

The thickness of the first sheet 6 or the second sheet 8 is preferably in a range of 10 μm to 100 μm. The thickness of the first sheet 6 or the second sheet 8 is more preferably in a range of 20 μm to 80 μm. The thickness of the first sheet 6 or the second sheet 8 is further more preferably in a range of 20 μm to 50 μm. In a case that the thickness of the first sheet 6 or the second sheet 8 is in a range of 10 μm to 100 μm, even if the sheet is interposed between the power generating unit 2 and the flat plate-shaped conductive member, the electrical conductivity between the power generating unit 2 and the flat plate-shaped conductive member is not lowered. In a case that the thickness of the first sheet 6 or the second sheet 8 is not more than 100 μm, the battery can lower the internal resistance. Further, in a case that the thickness of the first sheet 6 or the second sheet 8 is not more than 100 μm, the battery is capable of suppressing the increase in the volume thereof as much as possible. Furthermore, in a case that the thickness of the first sheet 6 or the second sheet 8 is not more than 100 μm, it is possible to produce a light-weight and small-sized battery.

### <First Flat Plate-shaped Conductive Member 7 or Second Flat Plate-Shaped Conductive Member 9>

As depicted in FIG. 2, the vanadium solid-salt battery 1 is provided with the first flat plate-shaped conductive member 7. The first flat plate-shaped conductive member 7 is arranged so that the first flat plate-shaped conductive member 7 makes surface contact with the first sheet 6. Further, the vanadium solid-salt battery 1 is provided with the second flat plate-shaped conductive member 9. The second flat plate-shaped conductive member 9 is arranged so that the second flat plate-shaped conductive member 9 makes surface contact with the second sheet 8.

The first flat plate-shaped conductive member 7 or the second plat-shaped conductive member 9 has a function of a terminal which leads the electricity of the power generating unit 2 to the outside thereof. As depicted in FIG. 1, the first flat plate-shaped conductive member 7 is preferably provided with the lead portion 7a extended from the third sheet 10a. Further, as depicted in FIG. 1, the second flat plate-shaped conductive member 9 is preferably provided with the lead portion 9a extended from the third sheet 10b. The size of the flat plate-shaped conductive members 7a and 9b is not particularly limited. It is preferable that in each of the flat plate-shaped conductive members 7a and 9b, a portion thereof different from the lead portion 7a or 9b has an area same as the area of the electrode member of the power generating unit, or has an area not less than the area of the electrode member of the power generating unit.

The flat plate-shaped conductive member is preferably a metallic plate. The flat plate-shaped conductive member is preferably an aluminum plate or a copper plate. The thickness of the flat plate-shaped conductive member is preferably in a range of 5 μm to 100 μm. The thickness of the flat plate-shaped conductive member is more preferably in a range of 10 μm to 50 μm. The thickness of the flat plate-shaped conductive member is further more preferably in a range of 20 μm to 50 μm. In a case that the thickness of the flat plate-shaped conductive member is not more than 100 μm, the battery is capable of suppressing the increase in the volume thereof as much as possible. In a case that the thickness of the flat plate-shaped conductive member is not more than 100 μm, it is possible to produce a light-weight and small-sized battery.

It is allowable to use such a configuration wherein the sheet which is conductive and impermeable to the electrolyte is integrally formed with the flat plate-shaped conductive member. As the configuration wherein the sheet which is conductive and impermeable to the electrolyte is integrally formed with the flat plate-shaped conductive member, it is allowable to use, for example, a configuration wherein the flat plate-shaped conductive member and a coating film (sheet) are integrally formed by coating the flat plate-shaped conductive member with a conductive rubber to form the coating film (sheet), and by performing drying therefor. Further, as the configuration wherein the sheet is integrally formed with the flat plate-shaped conductive member, it is allowable to use, for example, a configuration wherein a conductive film or conductive rubber formed to have sheet-like shape is heated and brought into pressurized contact with a flat plate-shaped conductive member, thereby forming the flat plate-shaped conductive member and the sheet (conductive film or conductive rubber) as an integrated member or item.

<Third Sheets 10a, 10b>

As depicted in FIG. 2, the vanadium solid-salt battery 1 is provided with the two third sheets 10a and 10b which cover or enclose the members of battery. The third sheets 10a and 10b may be, for example, a single sheet is folded and bent to be used. The single third sheet may have such a configuration wherein peripheral portions of the folded and bent sheet are bonded together such that for example the power generating unit 2 is interposed in a space defined by a folded and bent sheet. The third sheet contains resin. The resin is preferably at least one resin selected from the group consisting of: polypropylene, polyethylene terephthalate, polyether ether ketone, polyphenylene sulfide, polyimide, polyamide and polyethylene. As the third sheet, it is allowable to use a laminated film including a metallic layer and a sealant layer containing a resin. The third sheet is preferably formed of a material different from that forming the first or second sheet.

The vanadium solid-salt battery 1 is provided with the first bonding portion 12 at the peripheral portions, respectively, of the third sheets 10a and 10b. In the vanadium solid-salt battery 1, at least portions of the members of battery accommodated inside the third sheets 10a and 10b are pressure-bonded (joined). Here, the members of battery are the first flat plate-shaped conductive member 7, the first sheet 6, the power generating unit 2, the second sheet 8 and the second flat plate-shaped conductive member 9.

In a case that the third sheets 10a and 10b each contain a resin, the peripheral portions of the third sheets 10a and 10b are heated while being pressurized, in a state that the members of battery are present inside the third sheets 10a and 10b. Further, by heating the third sheets 10a and 10b while applying pressure to the third sheets 10a and 10b, the resin contained in each of the third sheets 10a and 10b is melted or fused. It is possible to form the first bonding portion 12 in the third sheets 10a and 10b by heating the peripheral portions of the third sheets 10a and 10b while pressurizing the peripheral portions. In a case of forming the first bonding portion 12 by heating the peripheral portions of the third sheets 10a and 10b, any positional shift (deviation) of the respective members is small as compared with a case of performing adhesion with an adhesive, thereby making it possible to perform the bonding easily.

In a case that the third sheets 10a and 10b are each a laminated film, it is possible to use a laminated film having a metallic layer and a sealant layer as exemplified below.

The metal forming the metallic layer can be exemplified by aluminum, aluminum alloy, copper, copper alloy, iron, stainless steel, titanium, titanium alloy, etc. The thickness of the metallic layer is preferably in a range of 5 μm to 100 μm. In a case that the thickness of the metallic layer is in the range of 5 μm to 100 μm, it is possible to maintain satisfactory water impermeability without allowing any pinhole, etc., to generate in the metallic layer.

The resin contained in the sealant layer can be exemplified by at least one resin selected from the group consisting of: polypropylene, polyethylene, polyester, polyacrylonitrile, ethylene-vinyl acetate copolymer (EVA), polyvinyl alcohol (PVA), modified polypropylene, modified polyethylene, polyvinyl acetate, polyethylene terephthalate, and ionomer resin. The resin contained in the sealant layer is preferably at least one resin selected from the group consisting of: polypropylene, polyethylene, and ionomer resin. The thickness of the sealant layer is preferably in a range of 5 μm to 200 μm. In a case that the thickness of the sealant layer is in the range of 5 μm to 200 μm, the airtightness in the seal portion of the battery is not impaired. In a case that the thickness of the sealant layer is in the range of 5 μm to 200 μm, the battery can be produced to be as a slim or thin-typed battery.

In a case that laminated films are used as the third sheets 10a and 10b, each of the laminated films preferably has a multi-layered structure having three or more layers wherein a metallic layer is arranged between at least two sealant layers. The three-layered structure of the laminated film can be exemplified, for example, by a three-layered structures respectively formed of: a polyethylene layer/an aluminum layer/a polyethylene terephthalate layer; a polypropylene layer/an aluminum layer/a polyethylene terephthalate layer; and an ionomer resin layer/an aluminum layer/a polyethylene terephthalate layer.

Although the thickness of each of the third sheets 10a and 10b is not particularly limited, the thickness of each of the third sheets 10a and 10a is preferably in a range of 15 μm to 250 μm. The thickness of each of the third sheets 10a and 10a is more preferably in a range of 25 μm to 200 μm, further more preferably in a range of 50 μm to 150 μm. In a case that the thickness of the third sheet 10 (third sheets 10a and 10a) is not less than 15 μm, the strength of the third sheet 10 is sufficient. Further, in the case that the thickness of the third sheet 10 is not less than 15 μm, the third sheet 10 is capable of pressure-bonding (pressure-joining) the members of battery accommodated inside the third sheet 10. Furthermore, in the case that the thickness of the third sheet 10 is not more than 250 μm, the increase in the volume of the battery is suppressed as much as possible, which in turn makes it possible to realize a small-sized and light-weight battery.

### <Vanadium Solid-Salt Battery>

As depicted in FIG. 2, the vanadium solid-salt battery 1 is provided with a second bonding portion 11 bonding the first sheet 6 and the second sheet 8 with an adhesive in a state that the separator 5 is interposed between the first and second sheets 6 and 8. The second bonding portion 11 is preferably formed at the peripheral portions of the first and second sheets 6 and 8. Owing to the provision of the second bonding portion 11 bonding the first and second sheets 6 and 8 with the separator 5 interposed therebetween, the power generating unit 2 is pressure-bonded to the first and second sheets 6 and 8. The vanadium solid-salt battery 1 is provided with the second bonding portion 11 bonding the first and second sheets 6 and 8 with the separator 5 interposed therebetween, thereby partitioning the first electrode member 3 and the second electrode member 4 from each other by the separator 5, without allowing the electrolytes contained in the first and second electrode members 3 and 4 to mix with each other.

The second bonding portion 11 provided in the vanadium solid-salt battery 1 also bonds the first sheet 6 and the first flat plate-shaped conductive member 7. Further, the second bonding portion 11 provided in the vanadium solid-salt battery 1 also bonds the second sheet 8 and the second flat plate-shaped conductive member 9. The power generating unit 2, the first and second sheets 6 and 8 with the separator 5 interposed therebetween, the first flat plate-shaped conductive member 7 and the second flat plate-shaped conductive member 8 are pressure-bonded by the second bonding portion 11 in a stable state. The lead portion 7a as an extended portion of the first flat plate-shaped conductive member 7 is preferably provided with an adhesion portion (bonding portion) at which a portion, of the lead portion 7a, contacting with the edge portion of the first sheet 6 is adhered to the edge portion. Further, the lead portion 9a as an extended portion of the second flat plate-shaped conductive member 9 is preferably provided with an adhesion portion (bonding portion) at which a portion, of the lead portion 9a, contacting with the edge portion of the second sheet 8 is adhered to the edge portion.

In the vanadium solid-salt battery 1, the power generating unit 2 is sealed by the second bonding portion 11 bonding the peripheral portions of the first and second sheets 6 and 8. In the vanadium solid-salt battery 1, any leakage of the electrolytic liquid contained in the power generating unit 2 is prevented in an assured manner by the second bonding portion 11 bonding the peripheral portions of the first and second sheets 6 and 8.

The adhesive composing the bonding portion is not particularly limited. The adhesive, however, can be exemplified by an adhesive including a polyethylene resin, a polypropylene resin, an ionomer resin, an acid-modified olefin resin, a thermo-setting resin which are insulating resins. The thermo-setting resin can be exemplified by a phenol resin, an unsaturated polyester resin, an epoxy resin, etc.

The vanadium solid-salt battery 1 is provided with the first bonding portion 12 at the peripheral portions of the two third sheets 10a and 10b. In the vanadium solid-salt battery 1, at least portions of the members of battery, accommodated in the two third sheets 10a and 10b, are pressure-bonded to each other by the first bonding portion 12 provided at the peripheral portions of the two third sheets 10a and 10b. Here, the members of battery are the first flat plate-shaped conductive member 7, the first sheet 6, the power generating unit 2, the second sheet 8 and the second flat plate-shaped conductive member 9. At least portions of the members of battery are pressure-bonded, and thus the vanadium solid-salt battery 1 is capable of improving the electrical conductivity among the respective members and to reduce the internal resistance.

In an embodiment of the vanadium solid-salt battery 1, FIG. 1 or FIG. 2 depicts the configuration wherein the single power generating unit 2 is accommodated in the third sheets 10a and 10b. The vanadium solid-salt battery 1 is, however, not limited to the configuration accommodating the single power generating unit 2. For example, the vanadium solid-salt battery 1 may be configured so that a plurality of pieces of the power generating unit 2 are accommodated in the third sheets 10a and 10b. For example, in the vanadium solid-salt battery 1 containing two pieces of the power generating unit, the first flat plate-shaped conductive member, the first sheet, the power generating unit, the second sheet, the second flat plate-shaped conductive member, a fourth sheet, a second power generating unit, a fifth sheet, and a third flat plate-shaped conductive member are arranged in this order. These members of battery are accommodated inside the third sheet. The third flat plate-shaped conductive member is preferably an aluminum plate or a copper plate. Each of the fourth sheet and the fifth sheet is preferably a conductive film, a sheet-shaped conductive rubber or a graphite sheet, similarly to the first or second sheet. The configurations of the first to fifth sheets are indicated below.

First sheet: sheet which is conductive and impermeable to the electrolyte

Second sheet: sheet which is conductive and impermeable to the electrolyte

Two third sheets: sheets which are impermeable to the electrolyte

Fourth sheet: sheet which is conductive and impermeable to the electrolyte

Fifth sheet: which is conductive and impermeable to the electrolyte

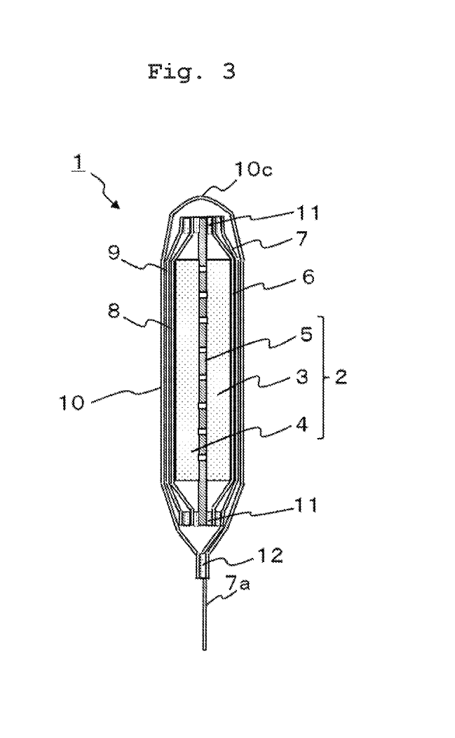

FIG. 3 is a view depicting an image of cross-section of a portion of another embodiment of the vanadium solid-salt battery 1. As depicted in FIG. 3, the vanadium solid-salt battery 1 is provided with a third sheet 10 having a folded and bent portion 10c at which a single sheet is folded in two. The third sheet 10 covers the first flat plate-shaped conductive member 7 and the second flat plate-shaped conductive member 9 interposed between (in a space defined inside) the third sheet 10 folded in two. The vanadium solid-salt battery 1 is provided with a first bonding portion 12 bonding peripheral portions in three sides of the third sheet 10 which are different from the folded and bent portion 10c. As depicted in FIG. 3, in the vanadium solid-salt battery 1, the single third sheet 10 is folded and bent, and the members of battery are interposed inside the folded and bent third sheet 10. The vanadium solid-salt battery 1 is not limited to the aspect accommodating a single power generating unit, and may accommodate a plurality of pieces of the power generating unit.

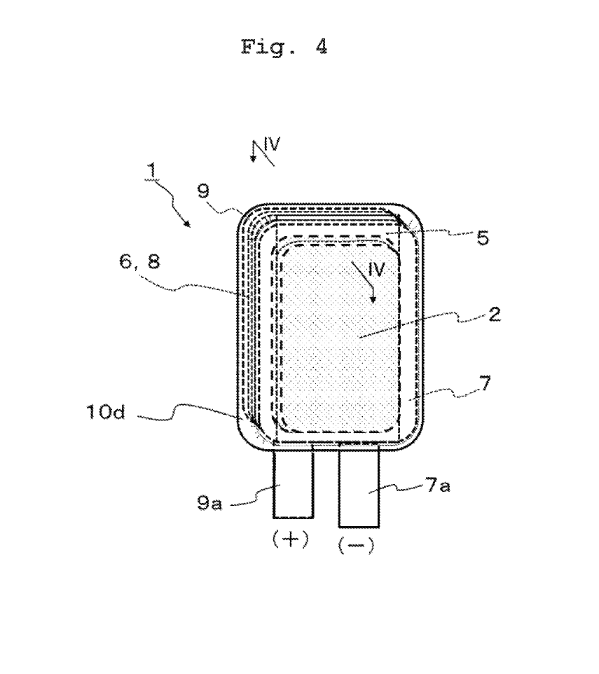

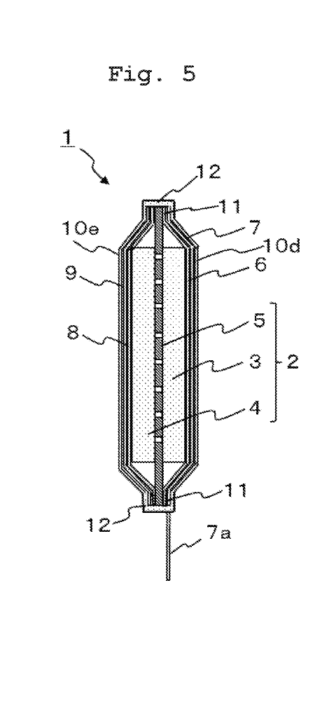

FIG. 4 is a perspective view depicting the schematic configuration of yet another embodiment of the vanadium solid-salt battery 1. FIG. 5 is a view depicting an image of cross-section (cross-section taken along IV-IV line) of a portion of the vanadium solid-salt battery of FIG. 4. The vanadium solid-salt battery 1 of this embodiment is an example using a first flat plate-shaped conductive member 7 and a first sheet 6 which are integrally formed and a second flat plate-shaped conductive member 9 and a second sheet 8 which are integrally formed. Each of the first and second sheets 6 and 8 used in the vanadium solid-salt battery 1 includes a resin which is melt and cured by heat. As depicted in FIG. 5, in the vanadium solid-salt battery 1, a separator 5 of a power generating unit 2 is interposed between the first flat plate-shaped conductive member 7 and the first sheet 6 which are integrally formed, and the second flat plate-shaped conductive member 9 and the second sheet 8 which are integrally formed. The vanadium solid-salt battery 1 is provided with a second bonding portion 11 at which the first and second sheets 6 and 8 are heated and bonded to each other.

Further, as depicted in FIG. 4 or FIG. 5, in the vanadium solid-salt battery 1, two third sheets 10d and 10e are arranged respectively outside of the first flat plate-shaped conductive member 7 and the first sheet 6 which are integrally formed, and outside of the second flat plate-shaped conductive member 9 and the second sheet 8 which are integrally formed. The vanadium solid-salt battery 1 is provided with a first bonding portion 12 bonding peripheral portions of the two third sheets 10a and 10e. The vanadium solid-salt battery 1 has a configuration wherein the members of battery are accommodated inside the two third sheets 10d and 10e.

Next, a method of producing the vanadium solid-salt battery will be explained.

### <Method of Producing Vanadium Solid-Salt Battery>

In the method of producing the vanadium solid-salt battery 1, at first, a power generating unit 2 is prepared. The power generating unit 2 includes a first electrode member 3 and a second electrode member 4 each of which contains vanadium ion or positive ion including vanadium, a separator 5 which partitions the first and second electrode members 3 and 4 from each other, and an electrolyte. It is preferable to use, as the separator 5, a separator of which area is greater than those of the first and second electrode members 3 and 4.

Next, the first sheet 6 is arranged to make contact with at least a portion of one of the electrode members of the power generating unit 2. The first sheet 6 has conductivity, and does not allow the electrolyte to pass therethrough (is impermeable to the electrolyte). The first sheet 6 is preferably arranged to make surface contact with the first electrode member 3.

Next, the first flat plate-shaped conductive member 7 is arranged to make surface contact with the first sheet 6.

Then, the second sheet 8 is arranged to make surface contact with at least a portion of the other of the electrode members. The second sheet 8 has conductivity, and does not allow the electrolyte to pass therethrough. The second sheet 8 is preferably arranged to make surface contact with the second electrode member 4.

Next, the second flat plate-shaped conductive member 9 is arranged to make surface contact with the second sheet 8.

In such a manner, the members of battery are configured by arranging the first flat plate-shaped conductive member 7, the first sheet 6, the power generating unit 2, the second sheet 8 and the second flat plate-shaped conductive member 9 in this order. The separator 5 of the power generating unit 2 is arranged between the first sheet 6 and the second sheet 8.

Next, the first sheet 6, the separator 5 and the second sheet 8 are adhered to one another with an adhesive, thereby forming the second bonding portion 11. In a case that the adhesive contains a thermosetting resin, it is preferred that the adhesion is executed while performing heating up to a temperature in a range of 140 degrees Celsius to 200 degrees Celsius. In a case that the adhesive contains a thermoplastic resin, it is preferred that the adhesion is executed while performing heating up to a temperature in a range of 140 degrees Celsius to 200 degrees Celsius. Alternatively, the first and second sheets 6 and 8 may be adhered to each other by the thermal sealing method, in a state that the separator 5 is interposed between the first and second sheets 6 and 8, thereby forming the second bonding portion 11. In a case that the bonding portion is formed by the thermal sealing method, it is preferable that the bonding is performed at a temperature in a range of 140 degrees Celsius to 200 degrees Celsius. In a case that each of the first and second sheets 6 and 8 contains an adhesive, the first and second sheets 6 and 8 can be bonded to each other by the thermal sealing method, thereby forming the second bonding portion 11. In a case that the heating temperature during the bonding is in the range of 140 degrees Celsius to 200 degrees Celsius, the first sheet 6 and the second sheet 8 are bonded, while the sheets are not affected by any shrinkage, etc., due to the heating. Further, in a case that the heating temperature is not more than 200 degrees Celsius, the first sheet 6 and the second sheet 8 are bonded, while the power generating unit 2 is not affected by the heating, such as boiling of the electrolyte, etc.

Next, the third sheet 10 is arranged to cover the first flat plate-shaped conductive member 7 and the second flat plate-shaped conductive member 9. The third sheet 10 may be composed of two third sheets, or may be a single third sheet. A vanadium solid-salt battery using two third sheets is exemplified by the vanadium solid-salt battery using the two third sheets 10a and 10d, as depicted in FIG. 2, and the vanadium solid-salt battery using the two third sheets 10d and 10e, as depicted in FIG. 5. A vanadium solid-salt battery using the single third sheet is exemplified by the vanadium solid-salt battery using the single third sheet 10 having the folded and bent portion 10c, as depicted in FIG. 3. Finally, in the vanadium solid-salt battery 1, the periphery portion of the third sheet is adhered so as to accommodate the members of battery inside the third sheet. In a case that a laminated film is used as the third sheet, it is possible to perform the bonding for the third sheet with, for example, the thermal sealing method by heating the sheet while applying the pressure to the sheet.

The vanadium solid-salt battery uses the third sheet which can realize the bonding by being heated and pressurized, as an exterior member accommodating the members of battery, without using a cell case formed of plastic, etc. In the vanadium solid-salt battery, the third sheet is used to thereby make it possible to form the bonding portion easily at the peripheral portion of the third sheet, in a state that the members of battery are accommodated inside the third sheet. By forming the first bonding portion at the peripheral portion of the third sheet of the vanadium solid-salt battery, the battery can be produced not via any complex steps.

As described above, in the vanadium solid-salt battery of the present disclosure, the peripheral portion of the third sheet accommodating the power generating unit therein is bonded to thereby prevent the leakage of the electrolyte. In the vanadium solid-salt battery of the present disclosure, the peripheral portion of the third sheet is bonded to thereby pressure-bond at least portions of the first flat plate-shaped conductive member, the first sheet, the power generating unit, the second sheet and the second flat plate-shaped conductive member which are accommodated inside the third sheet. The vanadium solid-salt battery of the present disclosure is capable of improving the electrical conductivity to thereby reduce the internal resistance.

### EXAMPLES

Next, a specific aspect of the present disclosure will be explained based on an example, together with a comparative example. However, the present disclosure is not limited and is not restricted to the example and comparative example.

### <Electrode Member>

As the carbon material, a commercially available carbon felt was used. The basis weight of the carbon felt was 330 g/m², the thickness of the carbon felt was 4.2 mm, and the dimension of the carbon felt was vertical: 2 cm and horizontal: 2 cm.

### <Solution for Deposition of Active Material for Negative Electrode>

A preparatory solution for deposition of active material could be obtained by adding sulfuric acid to vanadyl sulfate (IV).nH₂O(VOSO₄.nH₂O) to prepare a mixture of 1 L, followed by being agitated. The preparatory solution was subjected to the electrolytic reduction. As working electrodes for performing the electrolytic reduction, platinum plates were used. As a diaphragm for performing the electrolytic reduction, an ion-exchange membrane (“SELEMION (trade name) APS”, manufactured by Asahi Glass Co., Ltd.) was used. At first, the preparatory solution was poured into a beaker-shaped cell. Next, gas bubbling was conducted by using argon (Ar) gas for the preparatory solution poured into the beak-shaped cell. Subsequently, the electrolytic reduction was performed for the preparatory solution with a constant voltage of 1 A for 5 hours, while the temperature of the preparatory solution was maintained at 15 degrees Celsius and while the bubbling was continued with the Ar gas. Afterwards, the preparatory solution was poured from the beaker-shaped cell into a petri dish. Next, the preparatory solution poured into the petri dish was left as it was in the air for 12 hours. After the preparatory solution was left in the air as it was for 12 hours, the present disclosers visually confirmed that the color of the preparatory solution had changed from purple to green completely. Next, the preparatory solution was dried at reduced pressure (degree of vacuum: not more than 1.0×10⁵ Pa) at the room temperature (about 20 degrees Celsius ±5 degrees Celsius) for 1 week. Afterwards, 854 g of vanadium sulfate (III).nH₂O (content ratio of (V₂(SO₄)₃: 57.1%; V₂(SO₄)₃: 488 g; 2.5 mol) could be obtained from the preparatory solution. A solution for deposition of active material for negative electrode was obtained by adding 2 M (mol/L) sulfuric acid to the obtained vanadium sulfate (III).nH₂O(V₂(SO₄)₃.nH₂O) to prepare a mixture of 1 L, followed by being agitated.

### <Electrode Member for Negative Electrode>

Regarding the electrode member for the negative electrode, at first, 4 mL of the solution for deposition of active material for negative electrode, containing 2.5 M (mol/L) vanadium sulfate (III).nH₂O, was immersed per 4 cm² of the carbon material. Afterwards, the carbon material having the solution for deposition of active material for negative electrode immersed therein was dried for 1 hour under a condition of 60 degrees Celsius and 0.01 Mpa. Finally, the first electrode member for the negative electrode after the drying supported a deposited substance containing vanadium ion of which oxidation number is changed between divalence and trivalence. The amount of the deposited substance supported on the first electrode member was 0.61 g/cm².

### <Solution for Deposition of Active Material for Positive Electrode>

A solution for deposition of active material for positive electrode could be obtained by adding 2M (2 mol/L) of sulfuric acid to 566 g of vanadyl sulfate (IV).nH₂O(VOSO₄.nH₂O) (content ratio of VOSO₄: 72%; VOSO₄: 408 g, 2.5 mol) to prepare a mixture of 1 L, followed by being agitated.

### <Electrode Member for Positive Electrode>

Regarding the electrode member for the positive electrode, at first, 4 mL of the solution for deposition of active material for positive electrode, containing 2.5 M (mol/L) vanadyl sulfate (IV).H₂O, was immersed per 4 cm² of the carbon material. Afterwards, the carbon material having the solution for deposition of active material for positive electrode immersed therein was dried for 1 hour under a condition of 60 degrees Celsius and 0.01 Mpa. The second electrode member for the positive electrode after the drying supported a deposited substance containing positive ion containing vanadium of which oxidation number is changed between tetravalence and pentavalence. The amount of the deposited substance supported on the second electrode member was 1.0 g/cm².

### <Separator 5>

As the separator 5, an ion-exchange membrane “SELEMION (trade name) APS” (manufactured by Asahi Glass Co., Ltd.; dimension: vertical: 2.5 cm and horizontal: 2.5 cm) was used.

### <Power Generating Unit 2>

The power generating unit 2 was formed by arranging the separator 5 between the first electrode member 3 and the second electrode member 4.

### <First Sheet 6 or Second Sheet 8>

As the first sheet 6 or the second sheet 8, a graphite sheet (trade name: “Graphinity”, model number: XGX-040, manufactured by Kaneka Corporation; thickness: 40 μm; dimension: vertical 2.5 cm and horizontal 2.5 cm) was used.

### <First Flat Plate-Shaped Conductive Member 7 or Second Flat Plat-Shaped Conductive Member 9>

As the first flat plate-shaped conductive member 7 or the second flat plate-shaped conductive member 9, a copper plate having a thickness of 10 μm (model name: rolled copper foil, model number: C1100R, manufactured by Mitsui Sumitomo Metal Mining Brass & Copper Co., Ltd.) was used. The first flat plate-shaped conductive member 7 or the second flat plate-shaped conductive member 9 had a portion contacting with a surface of the first sheet 6 or the second sheet 8, and a lead portion extending with the portion contacting with the surface of the first sheet 6 or the second sheet 8. In the first flat plate-shaped conductive member 7 or the second flat plate-shaped conductive member 9, the dimension of the portion contacting with the surface of the first sheet 6 or the second sheet 8 was vertical: 2.5 cm and horizontal: 2.5 cm. Further, in the first flat plate-shaped conductive member 7 or the second flat plate-shaped conductive member 9, the dimension of the lead portion was vertical: 2.0 cm and horizontal: 0.5 cm.

### <Adhesive>

As the adhesive, an ionomer resin (trade name: Hi-Milan, manufactured by Du Point-Mitsui Polychemicals Co., Ltd.) was used.

### <Third Sheet>

As the third sheet, a laminated film having a three-layered structure of a sealant layer (polypropylene)/a metallic layer (aluminum)/a protective layer (polyethylene terephthalate) was used. The thickness of the sealant layer in the third sheet was 50 μm, and the thickness of the metallic layer in the third sheet was 10 μm. The entire thickness of the laminated film as the third sheet was 70 μm. The dimension of the third sheet was vertical: 3.0 cm and horizontal: 3.0 cm.

### Example 1

As depicted in FIG. 1, the vanadium solid-salt battery 1 is provided with the power generating unit 2. The power generating unit 2 includes the first electrode member 3, the second electrode member 4 and the separator 5 which partitions the first electrode member 3 and the second electrode member 4 from each other. At first, the first flat plate-shaped conductive member 7, the first sheet 6, the first electrode member 3, the separator 5, the second electrode member 4, the second sheet 8 and the second flat plate-shaped conductive member 9 were arranged in this order. With respect to the first sheet 6 and the second sheet 8, the separator 5 was interposed between these first and second sheets 6 and 8. With respect to the first sheet 6 and the second sheet 8, three sides among the four sides of the first and second sheets 6 and 8 were adhered to each other with an adhesive, respectively, with only one side of each of the first and second sheets 6 and 8 was left to be open, thereby forming the second bonding portion 11. The first sheet 6 and the second sheet 8 which were adhered to each other at the respective three sides with the adhesive became bag-shaped. The power generating unit 2 was accommodated inside the first and second sheets 6 and 8. 0.6 mL of 2M (mol/L) sulfuric acid was added, as the electrolyte, to the power generating unit 2 existing inside the first and second sheets 6 and 8. In the vanadium solid-salt battery 1 after having the electrolyte added thereto, the first sheet 6 and the second sheet 8 each of which was open at one side thereof were adhered to each other with the adhesive. The second bonding portion 11 was formed at the peripheral portions of the first and second sheets 6 and 8. Further, the first sheet 6 was made to contact with the first flat plate-shaped conductive member 7. The first sheet 6 and the first flat plate-shaped conductive member 7 were adhered to each other with the adhesive at the peripheral portions thereof. Furthermore, the second sheet 8 was made to contact with the second flat plate-shaped conductive member 9. The second sheet 8 and the second flat plate-shaped conductive member 9 were adhered to each other with the adhesive at the peripheral portions thereof. The second bonding portion 11 of the vanadium solid-salt battery 1 is the portion at which the first flat plate-shaped conductive member 7, the first sheet 6, the separator 5, the second sheet 8 and the second flat plate-shaped conductive member 9 are adhered to each other (bonded together) by the adhesive.

Next, two third sheets 10a and 10b each formed of a laminated film were prepared. The third sheet 10a as one of the two third sheets was arranged to contact with the first flat plate-shaped conductive member 7. Further, the third sheet 10b as the other of the two third sheets was arranged to contact with the second flat plate-shaped conductive member 9. The two third sheets 10a and 10b were pressurized while peripheral portion thereof were heated. The peripheral portions of the two third sheets 10a and 10b were fused together by means of the thermal sealing method by which the peripheral portions of the two third sheets 10a and 10b were pressurized while being heated, thereby forming a first bonding portion 12. The heating temperature was 150 degrees Celsius. The heating and pressurizing time was 0.5 minutes. Further, with respect to the two third sheets 10a and 10b, the pressure application was performed while sandwiching and heating the peripheral portions of the two third sheets 10a and 10b with heating plates. The first bonding portion 12 of the vanadium solid-salt battery 1 is a portion at which the two third sheets 10a and 10b were fused together. The vanadium solid-salt battery 1 has such a configuration that the members of battery are accommodated inside the two third sheets 10a and 10b provided with the first bonding portion 12 at peripheral portions thereof. Here, the members of battery are the first flat plate-shaped conductive member 7, the first sheet 6, the power generating unit 2, the second sheet 8 and the second flat plate-shaped conductive member 9 which are arranged in this order. In the vanadium solid-salt battery 1, at least portions of the first flat plate-shaped conductive member 7, the first sheet 6, the power generating unit 2, the second sheet 8 and the second flat plate-shaped conductive member 9 are pressure-bonded (joined) by the first bonding portion 12 provided at the peripheral portions of the two third sheets 10a and 10b. The thickness of a stacking of the third sheet 10a, the first flat plate-shaped conductive member 7, the first sheet 6, the first electrode member 3, the separator 5, the second electrode member 4, the second sheet 8, the second flat plate-shaped conductive member 9 and the third sheet 10b, before formed with the first joining portion 12, was 6.5 mm. The vanadium solid-salt battery 1 provided with the first bonding portion 12 at the peripheral portions of the two third sheets 10a and 10b had a surface area of 9 cm², a thickness of 6.6 mm and a mass of 6.4 g.

### Comparative Example 1

A vanadium solid-salt battery 1 of Comparative Example 1 was provided with, as exterior material, two plate formed of vinyl chloride and having a dimension of 40 mm×40 mm×3 mm, and two frames formed of vinyl chloride, having a dimension of 20 mm×20 mm and configured to place electrode members therein. The positive and negative electrode bodies of the vanadium solid-salt battery were produced in the following manner. Regarding the positive electrode body, a first flat plate-shaped conductive member and a first sheet were arranged in this order on a first vinyl chloride plate. Further, regarding the positive electrode body, a first vinyl chloride frame was arranged on the first sheet. The positive electrode body was produced by arranging, inside the first vinyl chloride frame, the electrode member for the positive electrode used in Example 1. Regarding the negative electrode body, at first, a second flat plate-shaped conductive member and a second sheet were stacked in this order on a second vinyl chloride plate. Further, regarding the negative electrode body, a second vinyl chloride frame was arranged on the second sheet. The negative electrode body was produced by arranging, inside the second vinyl chloride frame, the electrode member for the negative electrode used in Example 1. As the electrolyte for the positive and negative electrode bodies, 0.6 mL of 2M (mol/L) sulfuric acid was added to each of the positive and negative electrode bodies. Regarding the positive and negative electrodes bodies, a separator was arranged between the electrode member for the positive electrode body and the electrode member for the negative electrode body. The positive and negative electrode bodies were superposed on each other with the separator being interposed or sandwiched therebetween. The vanadium solid-salt battery was assembled by joining, with a screw or screws, the first vinyl chloride plate for the positive electrode and the second first vinyl chloride plate for the negative electrode which were superposed on each other. The vanadium solid-salt battery of Comparative Example 1 had a surface area of 16 cm², a thickness of 12 mm and a mass of 25 g.

The electrical resistance (Ω·cm) of the vanadium solid-salt battery of each of Example 1 and Comparative Example 1 was measured by means of the AC impedance measurement method (applied voltage: 0.005 V, measuring frequency: 0.01 Hz to 1 MHz). The results of measurement are indicated in TABLE 1 as follows.

TABLE 1

| | Electrical Resistance | Volume |
|---|---|---|
| | (Ω · cm) | (cm³) |
| Example 1 | 0.28 | 5.94 |
| Comparative Example 1 | 0.41 | 19.2 |

### CONSIDERATION OF RESULTS

As indicated in TABLE 1, the vanadium solid-salt battery 1 of Example 1 had a lowered electrical resistance as compared with the vanadium solid-salt battery of Comparative Example 1. From this result, it is speculated that, in the vanadium solid-salt battery 1 of Example 1, the members of battery accommodated inside the third sheets were each pressure-bonded (joined) to another member adjacent thereto, owing to the provision of the first bonding portion 12 at the peripheral portions of the third sheets. The members of battery are the first flat plate-shaped conductive member 7, the first sheet 6, the power generating unit 2, the second sheet 8 and the second flat plate-shaped conductive member 9. The vanadium solid-salt battery 1 of Example 1 had an improved electrical conductivity and a reduced internal resistance.

Any leakage of the electrolyte, etc., was not confirmed in the vanadium solid-salt battery 1 of Example 1. From this result, it is speculated that, in the vanadium solid-salt battery 1 of Example 1, the power generating unit 2 containing the electrolyte was accommodated inside the third sheets provided with the first bonding portion 12 at the peripheral portions thereof, and thus the sealing property was improved. The vanadium solid-salt battery 1 of Example 1 was capable of preventing the leakage of the electrolyte since the vanadium solid-salt battery 1 was provided with the first bonding portion 12 at the peripheral portions of the third sheets. Note that any leakage of the electrolyte, etc., was not confirmed also in the vanadium solid-salt battery of Comparative Example 1.

The vanadium solid-salt battery 1 of Example 1 could be made light-weight, small-sized and with a small thickness, without being limited to the dimension of the cell.

Further, since the laminated films were used as the third sheets in the vanadium solid-salt battery 1 of Example 1, it is possible to perform bonding while applying pressure to and heating the peripheral portions of the laminated films used as the third sheets. In the vanadium solid-salt battery 1 of Example 1, it was possible to form the first bonding portion 12 by fusing the peripheral portions of the third sheets, and thus the vanadium solid-salt battery 1 of Example 1 was easily produced.

The vanadium solid-salt battery of the present disclosure is capable of improving the sealing property and preventing any leakage of the electrolyte. Further, the vanadium solid-salt battery of the present disclosure is capable of improving the electrical conductivity among the respective members, and lowering the internal resistance. The vanadium solid-salt battery of the present disclosure is very useful in that the vanadium solid-salt battery can be formed to have a light weight, small size and reduced thickness. Further, the vanadium solid-salt battery can realize a light-weight, solid and sturdy product packaging (product mounting). Furthermore, the vanadium solid-salt battery is widely usable not only in the field of large electric power storage, but also in personal computers, personal digital assistants (PDAs), digital cameras, digital media players, digital recorders, game devices, electrical appliances, vehicles, radio equipment, cellphones, etc., and is industrially useful.

What is claimed is:

1. A vanadium solid-salt battery comprising:
a power generating unit including a first electrode member and a second electrode member each of which contains vanadium ion or positive ion including vanadium, a separator which separates the first and second electrode members from each other, and an electrolyte;
a first sheet which is conductive and impermeable to the electrolyte and which makes contact with at least a portion of the first electrode member;
a first flat plate-shaped conductive member which makes surface contact with the first sheet;
a second sheet which is conductive and impermeable to the electrolyte and which makes contact with at least a portion of the second electrode member;
a second flat plate-shaped conductive member which makes surface contact with the second sheet;
a third sheet which is impermeable to the electrolyte and which covers the first and second flat plate-shaped conductive members; and
a first bonding portion which bonds a peripheral portion of the third sheet so that at least portions of the first flat plate-shaped conductive member, the first sheet, the power generating unit, the second sheet and the second flat plate-shaped conductive member are pressure-bonded in a state that the separator is sandwiched between the first and second sheets,
wherein the first flat plate-shaped conductive member, the first sheet, the power generating unit, the second sheet and the second flat plate-shaped conductive member are accommodated inside the third sheet.

2. The vanadium solid-salt battery according to claim 1, further comprising a second bonding portion which bonds a peripheral portion of the first sheet and a peripheral portion of the second sheet in a state that the separator included in the power generating unit is interposed between the first and second sheets,
wherein the power generating unit is arranged between the first sheet and the second sheet.

3. The vanadium solid-salt battery according to claim 1, wherein the first sheet or the second sheet is a conductive film, a sheet-shaped conductive rubber or a graphite sheet.

4. The vanadium solid-salt battery according to claim 1, wherein the first flat plate-shaped conductive member or the second flat plate-shaped conductive member is an aluminum plate or a copper plate.
